(19) United States
(12) Patent Application Publication
(10) Pub. No.: US 2002/0008948 A1
(43) Pub. Date: Jan. 24, 2002

(54) Magnetic transducer and thin film magnetic head

(75) Inventors: Tetsuro Sasaki, Tokyo (JP); Kosuke Tanaka, Tokyo (JP)

Correspondence Address: Oliff & Berridge PLC, P.O. Box 19928, Alexandria, VA, 22320, US

(73) Assignee: TDK CORPORATION

(21) Appl. No.: 09/733,934

(22) Filed: Dec. 12, 2000

(30) Foreign Application Priority Data
Dec. 20, 1999 (JP) 11-361829

(51) Int. Cl. G11B 5/39

(52) U.S. Cl. 360/324.12

(57) ABSTRACT

Provided are a magnetic transducer and a thin film magnetic head which can increase the amount of resistance change and the rate of resistance change.

A stack comprising a spin valve film has a stacked structure comprising an underlayer, a nickel-containing ferromagnetic layer, a cobalt-containing ferromagnetic layer, a nonmagnetic layer, a second ferromagnetic layer, an antiferromagnetic layer and a protective layer, which are stacked in order on the underlayer. The nickel-containing ferromagnetic layer contains at least Ni in a group consisting of Ni, Co and Fe, and the thickness thereof is 1 nm or less. The cobalt-containing ferromagnetic layer contains at least Co in a group consisting of Ni, Co and Fe, and the thickness thereof is more than 1 nm. The thickness of the cobalt-containing ferromagnetic layer is more than 1 nm, whereby the amount of resistance change and the rate of resistance change can be improved when the thickness of the nickel-containing ferromagnetic layer is within a range of 1 nm or less. Therefore, output can be increased and thus adaptation can be made to high recording density.

### BACKGROUND OF THE INVENTION

1. Field of the Invention

The invention relates to a magnetic transducer and a thin film magnetic head using the same. More particularly, the invention relates to a magnetic transducer and a thin film magnetic head which are capable of obtaining better resistance change properties.

2. Description of the Related Art

Recently, an improvement in performance of a thin film magnetic head has been sought in accordance with an increase in a surface recording density of a hard disk or the like. A composite thin film magnetic head, which has a stacked structure comprising a reproducing head having a magnetoresistive element (hereinafter referred to as an MR element) that is a type of magnetic transducer and a recording head having an inductive magnetic transducer, is widely used as the thin film magnetic head.

MR elements include an AMR element using a magnetic film (an AMR film) exhibiting an anisotropic magnetoresistive effect (an AMR effect), a GMR element using a magnetic film (a GMR film) exhibiting a giant magnetoresistive effect (a GMR effect), and so on.

The reproducing head using the AMR element is called an AMR head, and the reproducing head using the GMR element is called a GMR head. The AMR head is used as the reproducing head whose surface recording density exceeds 1 Gbit/inch² (0.16 Gbit/cm²), and the GMR head is used as the reproducing head whose surface recording density exceeds 3 Gbit/inch² (0.46 Gbit/cm²).

On the other hand, a “multilayered type (antiferromagnetic type)” film, an “inductive ferromagnetic type” film, a “granular type” film, a “spin valve type” film and the like are proposed as the GMR film. Of these types of films, the spin valve type GMR film is considered to have a relatively simple structure, to exhibit a great change in resistance even under a low magnetic field and to be suitable for mass production.

FIG. 19 shows the structure of a general spin valve type GMR film (hereinafter referred to as a spin valve film). A surface indicated by reference symbol S in FIG. 19 corresponds to a surface facing a magnetic recording medium. The spin valve film has a stacked structure comprising an underlayer 91, a first ferromagnetic layer 92 made of a ferromagnetic material, a nonmagnetic layer 94 made of a nonmagnetic material, a second ferromagnetic layer 95 made of a ferromagnetic material, an antiferromagnetic layer 96 made of an antiferromagnetic material and a protective layer 97, which are stacked in this order on the underlayer 91. Exchange coupling occurs on an interface between the second ferromagnetic layer 95 and the antiferromagnetic layer 96, and thus the orientation of magnetization Mp of the second ferromagnetic layer 95 is fixed in a fixed direction. On the other hand, the orientation of magnetization Mf of the first ferromagnetic layer 92 freely changes according to an external magnetic field. A direct current is passed through the second ferromagnetic layer 95, the nonmagnetic layer 94 and the first ferromagnetic layer 92 in the direction shown by the arrow I, for example. The current is subjected to resistance according to a relative angle between the orientation of the magnetization Mf of the first ferromagnetic layer 92 and the orientation of the magnetization Mp of the second ferromagnetic layer 95.

FIG. 20 is a schematic graph for describing the principle of the correlation between a signal magnetic field from the magnetic recording medium and resistance change of the spin valve film. When the orientation of the magnetization Mf of the first ferromagnetic layer 92 is substantially parallel to and the same as the orientation of the magnetization Mp of the second ferromagnetic layer 95, the resistance of the spin valve film takes on a minimum value (assumed to be R). The application of the signal magnetic field from the magnetic recording medium causes a change in the orientation of the magnetization Mf of the first ferromagnetic layer 92. The resistance of the spin valve film increases according to the relative angle between the magnetization Mf of the first ferromagnetic layer 92 and the magnetization Mp of the second ferromagnetic layer 95. Thus, the orientation of the magnetization Mf of the first ferromagnetic layer 92 becomes parallel to and opposite to the orientation of the magnetization Mp of the second ferromagnetic layer 95. At this time, the resistance of the spin valve film takes on a maximum value (R+AR). The rate of resistance change (in units of %) is expressed as the rate of the amount of resistance change AR to the minimum value R of the resistance, namely, ΔR/R×100. The rate of resistance change is sometimes called the MR ratio. Both a large amount of resistance change and a high rate of resistance change are desirable for high output.

Various studies for improving sensitivity of the spin valve film to the signal magnetic field have been made in recent years in which recording at ultra-high density over 20 Gbit/inch² (3.1 Gbit/cm²) has been desired. For example, one of the studies is that the rate of resistance change is improved by reducing a saturation magnetic flux density by reducing a thickness of the first ferromagnetic layer 92. However, a problem exists. When the first ferromagnetic layer 92 has a stacked structure comprising a layer containing NiFe (nickel-iron alloy) and a layer containing Co (cobalt), a reduction of the thickness of the first ferromagnetic layer 92 to 4 nm or less causes a sharp decrease in the amount of resistance change and the rate of resistance change (see the cited reference “Spin filter spin valve heads with ultrathin CoFe free layer”, 1999 Digests of INTERMAG 99 and the cited reference “Underlayer effect on magnetoresistance of top- and bottom-type spin valves”, Journal of applied physics). High output cannot be therefore obtained when the first ferromagnetic layer 92 is only thinned.

In order to solve the problem, another study is that the rate of resistance change is increased by a layer called a back-layer made of, for example, Cu (copper) sandwiched between the first ferromagnetic layer 92 and the underlayer 91 (see p. 402, the Proceedings of the 23rd Annual Meeting of THE MAGNETICS SOCIETY OF JAPAN). However, a problem exists in this case. Although the rate of resistance change increases, the amount of resistance change decreases because the resistance of the spin valve film decreases. In other words, both a large amount of resistance change and a high rate of resistance change cannot be obtained.

### SUMMARY OF THE INVENTION

The invention is designed to overcome the foregoing problems. It is an object of the invention to provide a magnetic transducer and a thin film magnetic head which can obtain a large amount of resistance change and a high rate of resistance change.

A magnetic transducer of the invention comprises a nonmagnetic layer having a pair of surfaces facing each other; a first ferromagnetic layer formed on one surface of the nonmagnetic layer; a second ferromagnetic layer formed on the other surface of the nonmagnetic layer; and an antiferromagnetic layer formed on the second ferromagnetic layer on the side opposite to the nonmagnetic layer, wherein the first ferromagnetic layer includes a nickel-containing ferromagnetic layer containing at least Ni in a group consisting of Ni (nickel), Co (cobalt) and Fe (iron), and a cobalt-containing ferromagnetic layer formed on the nickel-containing ferromagnetic layer on the side close to the nonmagnetic layer and containing at least Co in a group consisting of Ni, Co and Fe, a thickness of the nickel-containing ferromagnetic layer is 1 nm or less, and a thickness of the cobalt-containing ferromagnetic layer is more than 1 nm.

A thin film magnetic head of the invention has a magnetic transducer which comprises a nonmagnetic layer having a pair of facing surfaces; a first ferromagnetic layer formed on one surface of the nonmagnetic layer; a second ferromagnetic layer formed on the other surface of the nonmagnetic layer; and an antiferromagnetic layer formed on the second ferromagnetic layer on the side opposite to the nonmagnetic layer, wherein the first ferromagnetic layer includes a nickel-containing ferromagnetic layer containing at least Ni in a group consisting of Ni, Co and Fe, and a cobalt-containing ferromagnetic layer formed on the nickel-containing ferromagnetic layer on the side close to the nonmagnetic layer and containing at least Co in a group consisting of Ni, Co and Fe, a thickness of the nickel-containing ferromagnetic layer is 1 nm or less, and a thickness of the cobalt-containing ferromagnetic layer is more than 1 nm.

In the magnetic transducer or the thin film magnetic head of the invention, the thickness of the cobalt-containing ferromagnetic layer of the first ferromagnetic layer is more than 1 nm, whereby the amount of resistance change and the rate of resistance change are improved when the thickness of the nickel-containing ferromagnetic layer is 1 nm or less.

In the magnetic transducer of the invention, it is desirable that the thickness of the nickel-containing ferromagnetic layer is from 0.2 nm to 0.8 nm inclusive. Desirably, the thickness of the cobalt-containing ferromagnetic layer is 3.0 nm or less. Desirably, the nickel-containing ferromagnetic layer further contains at least one element in a group consisting of Ta (tantalum), Cr (chromium), Nb (niobium) and Rh (rhodium).

Desirably, the second ferromagnetic layer contains at least Co in a group consisting of Co and Fe. Desirably, the antiferromagnetic layer contains Mn (manganese) and at least one element in a group consisting of Pt (platinum), Ru (ruthenium), Rh and Ir (iridium). Desirably, the nonmagnetic layer contains at least one element in a group consisting of Cu, Au (gold) and Ag (silver).

Other and further objects, features and advantages of the invention will appear more fully from the following description.

### BRIEF DESCRIPTION OF THE DRAWINGS

FIG. 1 is a perspective view of a configuration of an actuator arm comprising a thin film magnetic head including an MR element according to a first embodiment of the invention;

FIG. 2 is a perspective view of a configuration of a slider of the actuator arm shown in FIG. 1;

FIG. 3 is an exploded perspective view of a structure of the thin film magnetic head according to the first embodiment;

FIG. 4 is a plan view of the thin film magnetic head shown in FIG. 3, showing the structure thereof viewed from the direction of the arrow IV of FIG. 3;

FIG. 5 is a sectional view of the thin film magnetic head shown in FIG. 3, showing the structure thereof viewed from the direction of the arrows along the line V-V of FIG. 4;

FIG. 6 is a sectional view of the thin film magnetic head shown in FIG. 3, showing the structure thereof viewed from the direction of the arrows along the line VI-VI of FIG. 4, i.e., the structure thereof viewed from the direction of the arrows along the line VI-VI of FIG. 5;

FIG. 7 is a perspective view of a structure of a stack of the MR element shown in FIG. 6;

FIG. 8 is a sectional view for describing a step of a method of manufacturing the thin film magnetic head shown in FIG. 3;

FIG. 9 is a sectional view for describing a step following the step of FIG. 8;

FIGS. 10A and 10B are sectional views for describing a step following the step of FIG. 9;

FIGS. 11A and 11B are sectional views for describing a step following the step of FIGS. 10A and 10B;

FIGS. 12A and 12B are sectional views for describing a step following the step of FIGS. 11A and 11B;

FIGS. 13A and 13B are sectional views for describing a step following the step of FIGS. 12A and 12B;

FIG. 14 is a perspective view of a structure of a stack according to a modification of the first embodiment;

FIG. 15 is a plot of the results of measurement of the amount of resistance change of examples;

FIG. 16 is a plot of the results of measurement of the rate of resistance change of the examples;

FIG. 17 is a plot of the results of measurement of the amount of resistance change of examples;

FIG. 18 is a plot of the results of measurement of the rate of resistance change of the examples;

FIG. 19 is a perspective view of a structure of a stack of a general MR element; and

FIG. 20 is a schematic graph for describing the principle of detection of a signal by means of the general MR element.

### DETAILED DESCRIPTION OF THE PREFERRED EMBODIMENTS

[First Embodiment]

<Structures of MR Element and Thin Film Magnetic Head>

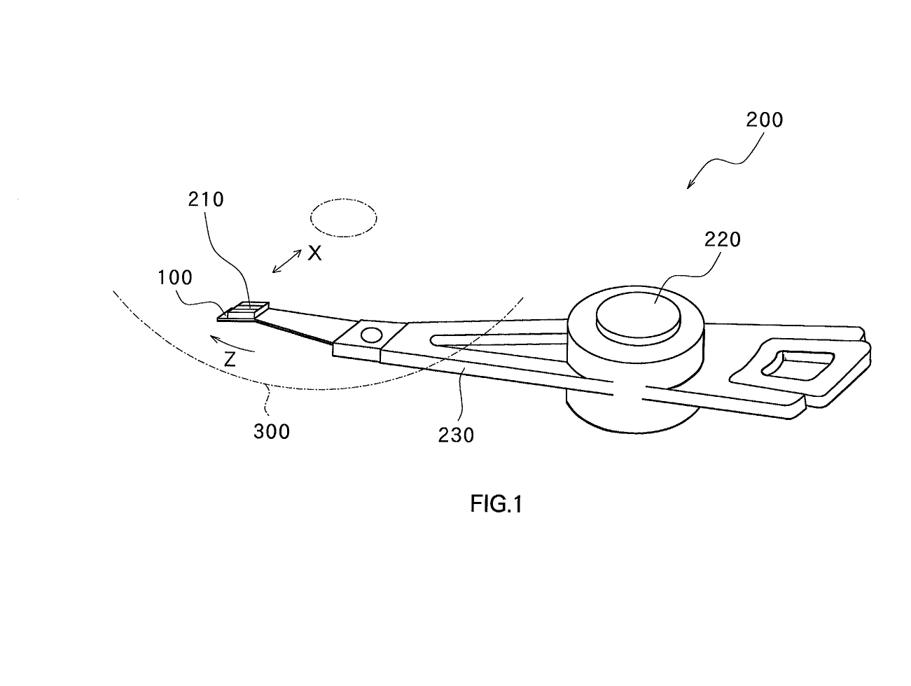

Firstly, the respective structures of an MR element that is a specific example of a magnetic transducer according to a first embodiment of the invention and a thin film magnetic head using the MR element will be described with reference to FIGS. 1 to 7.

FIG. 1 shows the configuration of an actuator arm 200 comprising a thin film magnetic head 100 according to the embodiment. The actuator arm 200 is used in a hard disk drive (not shown) or the like, for example. The actuator arm 200 has a slider 210 on which the thin film magnetic head 100 is formed. For example, the slider 210 is mounted on the end of an arm 230 rotatably supported by a supporting pivot 220. The arm 230 is rotated by a driving force of a voice coil motor (not shown), for example. Thus, the slider 210 moves in a direction x in which the slider 210 crosses a track line along a recording surface of a magnetic recording medium 300 such as a hard disk (a lower surface of the recording surface in FIG. 1). For example, the magnetic recording medium 300 rotates in a direction z substantially perpendicular to the direction x in which the slider 210 crosses the track line. The magnetic recording medium 300 rotates and the slider 210 moves in the above-mentioned manner, whereby information is recorded on the magnetic recording medium 300 or recorded information is read out from the magnetic recording medium 300.

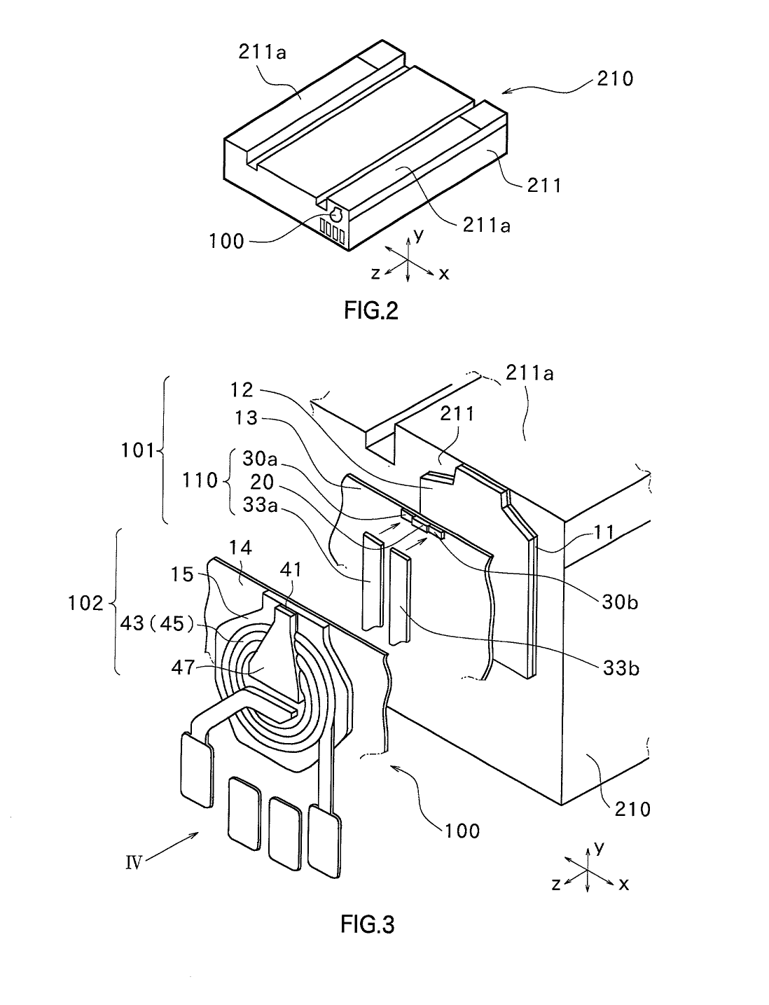

FIG. 2 shows the configuration of the slider 210 shown in FIG. 1. The slider 210 has a block-shaped base 211 made of Al₂O₃—TiC (altic), for example. The base 211 is substantially hexahedral, for instance. One face of the hexahedron closely faces the recording surface of the magnetic recording medium 300 (see FIG. 1). A surface facing the recording surface of the magnetic recording medium 300 is called an air bearing surface (ABS) 211a. When the magnetic recording medium 300 rotates, airflow generated between the recording surface of the magnetic recording medium 300 and the air bearing surface 211a allows the slider 210 to slightly move away from the recording surface in a direction y opposite to the recording surface. Thus, a clearance is created between the air bearing surface 211a and the magnetic recording medium 300. The thin film magnetic head 100 is provided on one side (the left side in FIG. 2) adjacent to the air bearing surface 211a of the base 211.

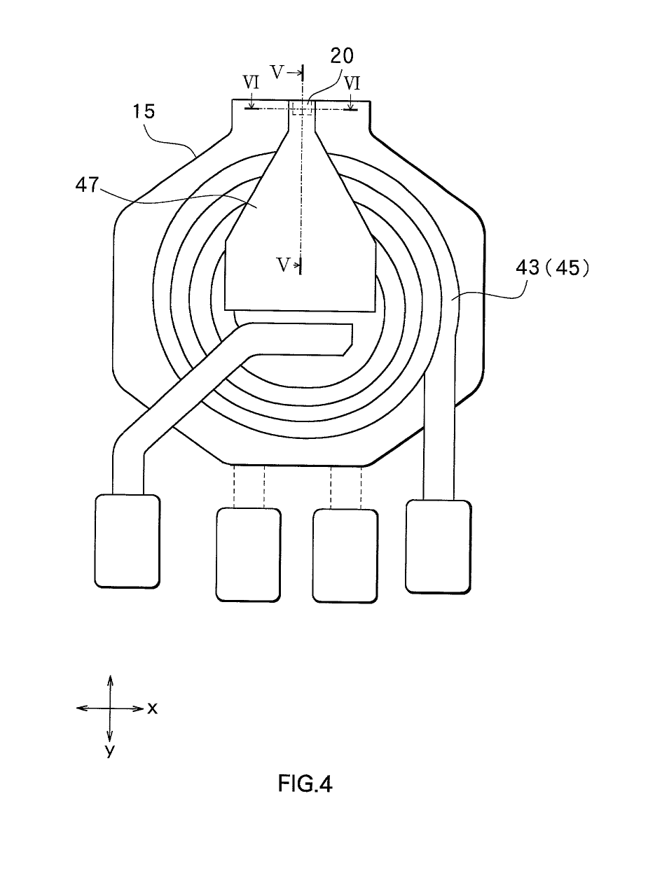

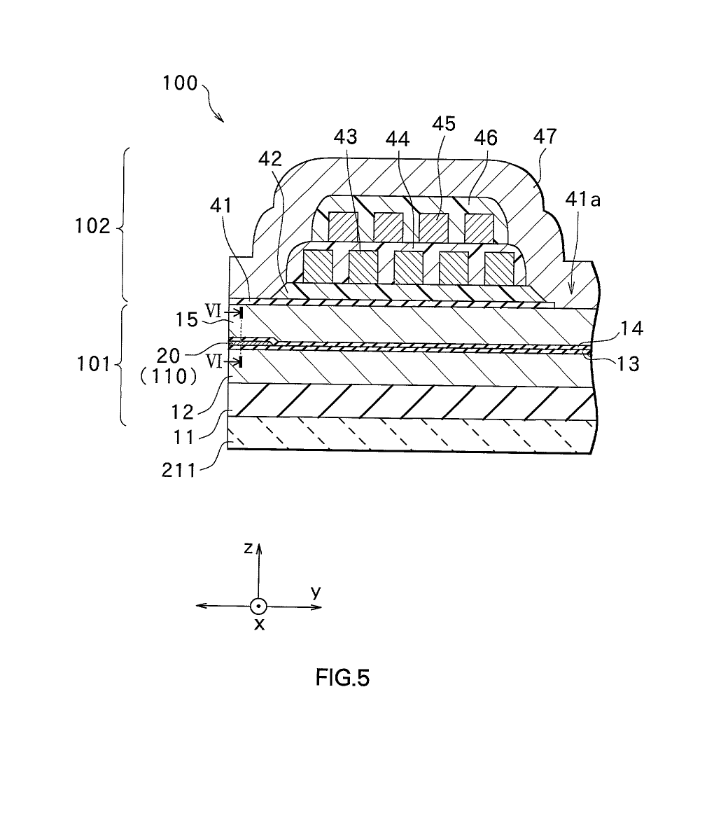

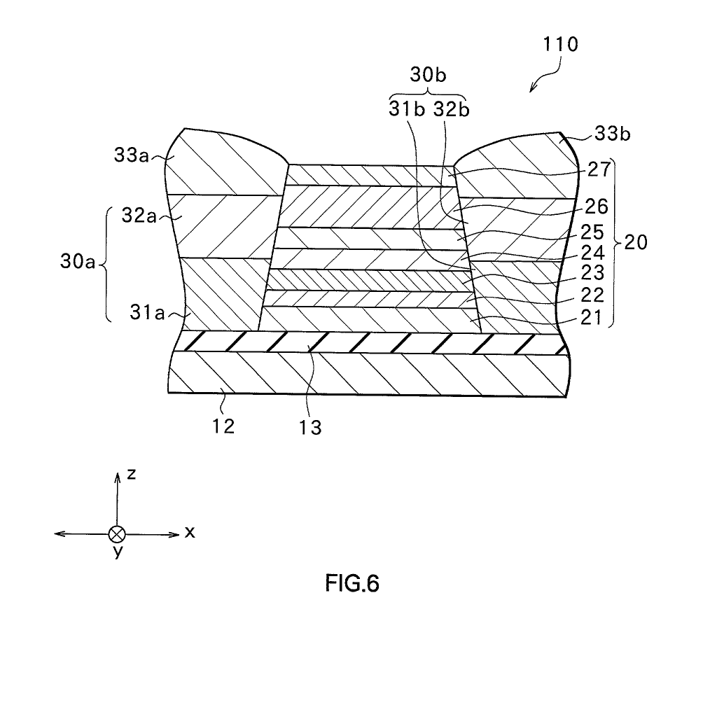

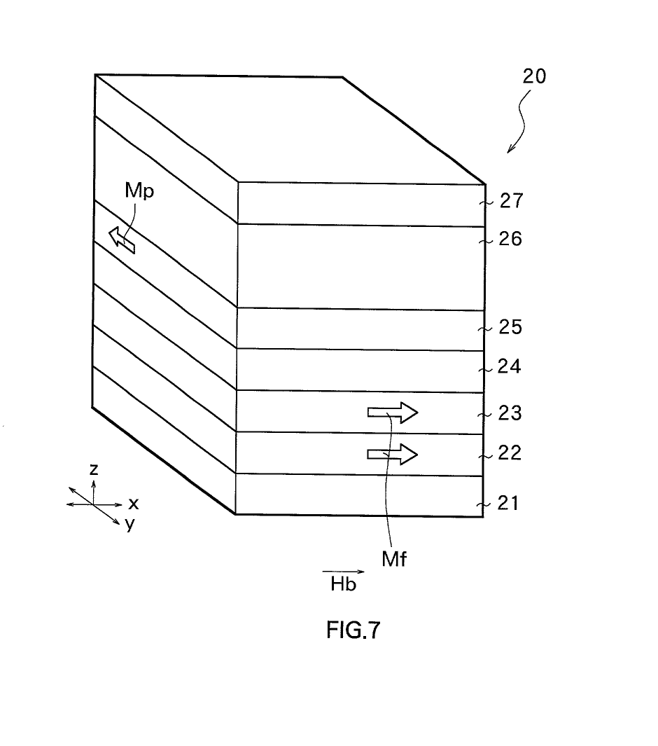

FIG. 3 is an exploded view of the structure of the thin film magnetic head 100. FIG. 4 shows a planar structure viewed from the direction of the arrow IV of FIG. 3. FIG. 5 shows a sectional structure viewed from the direction of the arrows along the line V-V of FIG. 4. FIG. 6 shows a sectional structure viewed from the direction of the arrows along the line VI-VI of FIG. 4, i.e., the direction of the arrows along the line VI-VI of FIG. 5. FIG. 7 shows a part of the structure shown in FIG. 6. The thin film magnetic head 100 has an integral structure comprising a reproducing head 101 for reproducing magnetic information recorded on the magnetic recording medium 300 and a recording head 102 for recording magnetic information on the track line of the magnetic recording medium 300.

As shown in FIGS. 3 and 5, for example, the reproducing head 101 has a stacked structure comprising an insulating layer 11, a bottom shield layer 12, a bottom shield gap layer 13, a top shield gap layer 14 and a top shield layer 15, which are stacked in this order on the base 211 close to the air bearing surface 211a. For example, the insulating layer 11 is 2 μm to 10 μm in thickness along the direction of stacking (hereinafter referred to as a thickness) and is made of Al₂O₃ (aluminum oxide). For example, the bottom shield layer 12 is 1 μm to 3 μm in thickness and is made of a magnetic material such as NiFe (nickel-iron alloy). For example, the bottom shield gap layer 13 and the top shield gap layer 14 are each 10 nm to 100 nm in thickness and are made of Al₂O₃ or AlN (aluminum nitride). For example, the top shield layer 15 is 1 μm to 4 μm in thickness and is made of a magnetic material such as NiFe. The top shield layer 15 also functions as a bottom pole of the recording head 102.

An MR element 110 including a stack 20 comprising a spin valve film is embedded in the bottom shield gap layer 13 and the top shield gap layer 14. The reproducing head 101 reads out information recorded on the magnetic recording medium 300 by utilizing electrical resistance of the stack 20 changing according to a signal magnetic field from the magnetic recording medium 300.

For example, as shown in FIGS. 6 and 7, the stack 20 has a stacked structure comprising an underlayer 21, a nickel-containing ferromagnetic layer 22, a cobalt-containing ferromagnetic layer 23, a nonmagnetic layer 24, a second ferromagnetic layer 25, an antiferromagnetic layer 26 and a protective layer 27, which are stacked in this order on the bottom shield gap layer 13. For example, the underlayer 21 is 5 nm in thickness and is made of Ta.

As shown in FIGS. 6 and 7, the nickel-containing ferromagnetic layer 22 is made of a magnetic material containing at least Ni in a group consisting of Ni, Fe and Co, for example. Preferably, the nickel-containing ferromagnetic layer 22 contains Ni and Fe. Preferably, the composition ratio of Ni to Fe is from 3.76 to 5.67 inclusive in terms of the weight ratio of Ni to Fe (Ni/Fe), or more preferably the composition ratio is from 4.0 to 5.0 inclusive. The composition ratio within the above-mentioned range facilitates controlling magnetostriction of the nickel-containing ferromagnetic layer 22. In some cases, the nickel-containing ferromagnetic layer 22 contains Co because Co is diffused into the nickel-containing ferromagnetic layer 22 from the cobalt-containing ferromagnetic layer 23. The nickel-containing ferromagnetic layer 22 may further contain, as an additive, at least one element in a group consisting of Ta, Cr, Nb and Rh. Desirably, the percentage of content of the additive is 30 wt % or less. Too high a percentage of content of the additive has an influence on magnetic properties of the nickel-containing ferromagnetic layer 22.

The cobalt-containing ferromagnetic layer 23 is made of a magnetic material containing at least Co in a group consisting of Co, Ni and Fe, for example. Preferably, the cobalt-containing ferromagnetic layer 23 contains Co, or Co and Fe. Preferably, the composition ratio of Co to Fe is 4.0 or more in terms of the weight ratio of Co to Fe (Co/Fe). The cobalt-containing ferromagnetic layer 23 may further contain an additive such as B (boron). Both the nickel-containing ferromagnetic layer 22 and the cobalt-containing ferromagnetic layer 23 constitute a first ferromagnetic layer sometimes called a free layer, and the orientations of magnetic fields thereof change according to the signal magnetic field from the magnetic recording medium.

The thickness of the nickel-containing ferromagnetic layer 22 is 1 nm or less, and the thickness of the cobalt-containing ferromagnetic layer 23 is more than 1 nm. When the thickness of the nickel-containing ferromagnetic layer 22 and the thickness of the cobalt-containing ferromagnetic layer 23 are within the above-mentioned range, both the amount of resistance change and the rate of resistance change can be improved. Furthermore, when the thickness of the nickel-containing ferromagnetic layer 22 is from 0.2 nm to 0.8 nm inclusive, a large amount of resistance change and a high rate of resistance change can be obtained. Moreover, when the thickness of the cobalt-containing ferromagnetic layer 23 is 3 nm or less, or more preferably within a range of from 1.5 nm to 3.0 nm, a larger amount of resistance change and a higher rate of resistance change can be obtained.

For example, the nonmagnetic layer 24 is 2.0 nm to 3.0 nm in thickness and is made of a nonmagnetic material containing at least one element in a group consisting of Cu, Au and Ag. For example, the second ferromagnetic layer 25 is 2 nm to 4.5 nm in thickness and is made of a magnetic material containing at least Co in a group consisting of Co and Fe. The second ferromagnetic layer 25 is sometimes called a pinned layer, and the orientation of magnetization thereof is fixed by exchange coupling on an interface between the second ferromagnetic layer 25 and the antiferromagnetic layer 26. Incidentally, in the embodiment, the orientation of magnetization of the second ferromagnetic layer 25 is fixed in the y direction.

For example, the antiferromagnetic layer 26 is 5 nm to 30 nm in thickness and is made of an antiferromagnetic material containing at least Mn in a group consisting of Mn, Pt (platinum), Ru (ruthenium), Ir (iridium) and Rh. Antiferromagnetic materials include a non-heat-treatment type antiferromagnetic material which exhibits antiferromagnetism even without heat treatment and induces an exchange coupling magnetic field between the antiferromagnetic material and a ferromagnetic material, and a heat-treatment type antiferromagnetic material which exhibits antiferromagnetism by heat treatment. The antiferromagnetic layer 26 may be made of either the non-heat-treatment type antiferromagnetic material or the heat-treatment type antiferromagnetic material.

Non-heat-treatment type antiferromagnetic materials include Mn alloy having γ-phase, and so on. Specifically, RuRhMn (ruthenium-rhodium-manganese alloy) and the like are included. Heat-treatment type antiferromagnetic materials include Mn alloy having regular crystal structures, and so on. Specifically, PtMn (platinum-manganese alloy) and the like are included. For example, the protective layer 27 is 5 nm in thickness and is made of Ta.

As shown in FIG. 6, magnetic domain control films 30a and 30b are provided on both sides of the stack 20, i.e., both sides along the direction perpendicular to the direction of stacking so as to match the orientation of magnetization of the nickel-containing ferromagnetic layer 22 to the orientation of magnetization of the cobalt-containing ferromagnetic layer 23 and thereby suppress so-called Barkhausen noise. For example, the magnetic domain control film 30a has a stacked structure comprising a magnetic domain controlling ferromagnetic film 31a and a magnetic domain controlling antiferromagnetic film 32a, which are stacked in this order on the bottom shield gap layer 13. The magnetic domain control film 30b has the same structure as the magnetic domain control film 30a has. The orientations of magnetizations of the magnetic domain controlling ferromagnetic films 31a and 31b are fixed by exchange coupling on the interfaces between the magnetic domain controlling ferromagnetic films 31a and 31b and the magnetic domain controlling antiferromagnetic films 32a and 32b. Thus, for example, as shown in FIG. 7, a bias magnetic field Hb to be applied to the nickel-containing ferromagnetic layer 22 and the cobalt-containing ferromagnetic layer 23 is generated in the x direction near the magnetic domain controlling ferromagnetic films 31a and 31b.

For example, the magnetic domain controlling ferromagnetic films 31a and 31b are each 10 nm to 50 nm in thickness and are provided corresponding to the nickel-containing ferromagnetic layer 22 and the cobalt-containing ferromagnetic layer 23. The magnetic domain controlling ferromagnetic films 31a and 31b are made of, for example, NiFe, or Ni, Fe and Co. In this case, the magnetic domain controlling ferromagnetic films 31a and 31b may be formed of a stacked film of NiFe and Co. For example, the magnetic domain controlling antiferromagnetic films 32a and 32b are each 5 nm to 30 nm in thickness and are made of an antiferromagnetic material. Although the antiferromagnetic material may be either the non-heat-treatment type antiferromagnetic material or the heat-treatment type antiferromagnetic material, the non-heat-treatment type antiferromagnetic material is preferable.

Lead layers 33a and 33b, which are formed of a stacked film of Ta and Au, a stacked film of TiW (titanium-tungsten alloy) and Ta, a stacked film of TiN (titanium nitride) and Ta or the like, are provided on the magnetic domain control films 30a and 30b, respectively, so that a current can be passed through the stack 20 through the magnetic domain control films 30a and 30b.

For example, as shown in FIGS. 3 and 5, the recording head 102 has a write gap layer 41 of 0.1 μm to 0.5 μm thick formed of an insulating film such as Al₂O₃ on the top shield layer 15. The write gap layer 41 has an opening 41a at the position corresponding to the center of thin film coils 43 and 45 to be described later. The thin film coils 43 of 1 μm to 3 μm thick and a photoresist layer 44 for coating the thin film coils 43 are formed on the write gap layer 41 with a photoresist layer 42 having a thickness of 1.0 μm to 5.0 μm for determining a throat height in between. The thin film coils 45 of 1 μm to 3 μm thick and a photoresist layer 46 for coating the thin film coils 45 are formed on the photoresist layer 44. In the embodiment, the description is given with regard to an example in which two thin film coil layers are stacked. However, the number of thin film coil layers may be one, or three or more.

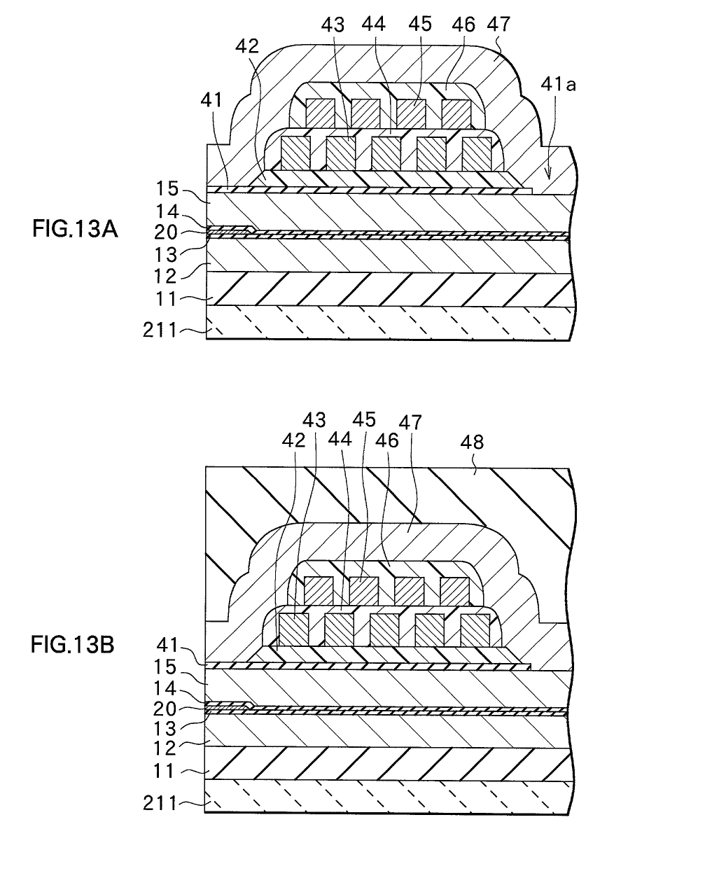

A top pole 47 of about 3 μm thick made of a magnetic material having high saturation magnetic flux density, such as NiFe or FeN (iron nitride), is formed on the write gap layer 41 and the photoresist layers 42, 44 and 46. The top pole 47 is in contact with and magnetically coupled to the top shield layer 15 through the opening 41a of the write gap layer 41 located at the position corresponding to the center of the thin film coils 43 and 45. Although not shown in FIGS. 3 to 6, an overcoat layer (an overcoat layer 48 in FIG. 13B) of 20 μm to 30 μm thick made of, for example, Al₂O₃ is formed on the top pole 47 so as to coat the overall surface. Thus, the recording head 102 generates a magnetic flux between the bottom pole, i.e., the top shield layer 15 and the top pole 47 by a current passing through the thin film coils 43 and 45 and magnetizes the magnetic recording medium 300 by the magnetic flux generated near the write gap layer 41, thereby recording information on the magnetic recording medium 300.

<Operation of MR Element and Thin Film Magnetic Head>

Next, a reproducing operation of the MR element 110 and the thin film magnetic head 100 configured as described above will be described with main reference to FIGS. 6 and 7.

In the thin film magnetic head 100, the reproducing head 101 (see FIG. 3) reads out information recorded on the magnetic recording medium 300. In the reproducing head 101 (see FIG. 3), for example, the orientation of magnetization Mp of the second ferromagnetic layer 25 is fixed in a -y direction by the exchange coupling magnetic field generated by exchange coupling on the interface between the second ferromagnetic layer 25 and the antiferromagnetic layer 26 of the stack 20. Magnetizations Mf of the nickel-containing ferromagnetic layer 22 and the cobalt-containing ferromagnetic layer 23 are oriented in the direction of the bias magnetic field Hb (the x direction) by the bias magnetic field Hb generated by the magnetic domain control films 30a and 30b. The orientation of the bias magnetic field Hb is substantially perpendicular to the orientation of the magnetization Mp of the second ferromagnetic layer 25.

For reading out information, a sense current that is a stationary electric current is passed through the stack 20 in, for example, the direction of the bias magnetic field Hb through the lead layers 33a and 33b. The current mainly passes through layers having relatively low electrical resistance, that is the nickel-containing ferromagnetic layer 22, the cobalt-containing ferromagnetic layer 23, the nonmagnetic layer 24 and the second ferromagnetic layer 25. When the signal magnetic field from the magnetic recording medium 300 (see FIG. 1) reaches the stack 20, the orientations of the magnetizations Mf of the nickel-containing ferromagnetic layer 22 and the cobalt-containing ferromagnetic layer 23 change. On the other hand, the orientation of the magnetization Mp of the second ferromagnetic layer 25 does not change even under the signal magnetic field from the magnetic recording medium 300 because the orientation thereof is fixed by the antiferromagnetic layer 26.

The current passing through the stack 20 is subjected to resistance according to a relative angle between the orientations of the magnetizations Mf of the nickel-containing ferromagnetic layer 22 and the cobalt-containing ferromagnetic layer 23 and the orientation of the magnetization Mp of the second ferromagnetic layer 25. The amount of change in resistance of the stack 20 is detected as the amount of change in voltage, and thus information recorded on the magnetic recording medium 300 is read out. In this case, the thickness of the nickel-containing ferromagnetic layer 22 is 1 nm or less, and the thickness of the cobalt-containing ferromagnetic layer 23 is more than 1 nm. Thus, the amount of resistance change and the rate of resistance change are improved. Therefore, high output can be obtained.

<Method of Manufacturing MR Element and Thin Film Magnetic Head>

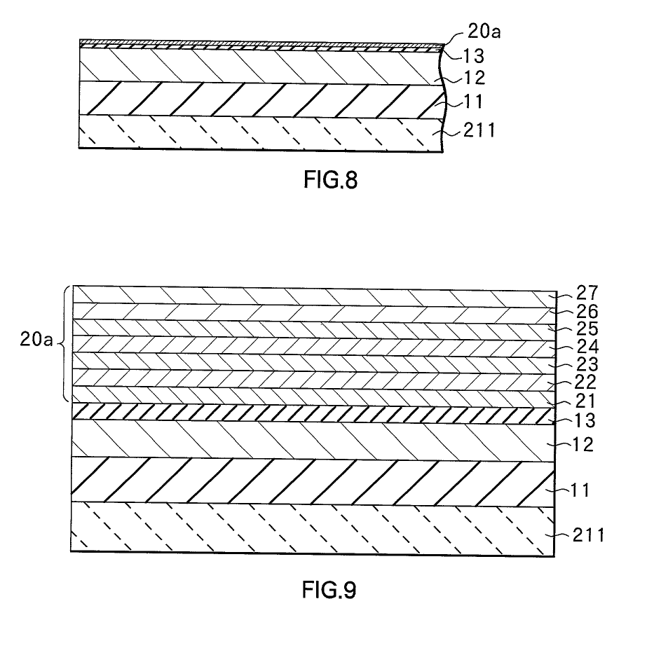

Next, a method of manufacturing the MR element 110 and the thin film magnetic head 100 will be described. FIGS. 8 to 13A and 13B are sectional views showing steps of a manufacturing process. FIGS. 8, 12A and 12B and 13A and 13B show a sectional structure taken along the line V-V of FIG. 4. FIGS. 9 to 11A and 11B show a sectional structure taken along the line VI-VI of FIG. 4.

In the method of manufacturing according to the embodiment, first, as shown in FIG. 8, for example, the insulating layer 11, the bottom shield layer 12 and the bottom shield gap layer 13 are formed in sequence on one side of the base 211 made of Al₂O₃—TiC by using the materials mentioned in the description of the structure. The insulating layer 11 and the bottom shield gap layer 13 are formed by, for example, sputtering, and the bottom shield layer 12 is formed by, for example, plating. After that, a stacked film 20a for forming the stack 20 is formed on the bottom shield gap layer 13.

A step of forming the stack 20 will be described in detail. First, as shown in FIG. 9, the underlayer 21, the nickel-containing ferromagnetic layer 22, the cobalt-containing ferromagnetic layer 23, the nonmagnetic layer 24, the second ferromagnetic layer 25, the antiferromagnetic layer 26 and the protective layer 27 are formed in sequence on the bottom shield gap layer 13 by, for example, sputtering using the materials mentioned in the description of the structure. The step takes place in, for example, a vacuum chamber (not shown) under vacuum at an ultimate pressure of 1.3×10⁻⁸ Pa to 1.3×10⁻⁶ Pa and a deposition pressure of 1.3×10⁻³ Pa to 1.3 Pa. To form the antiferromagnetic layer 26 by the non-heat-treatment type antiferromagnetic material, the antiferromagnetic layer 26 is formed with the magnetic field applied in the y direction (see FIG. 7), for example. In this case, the orientation of the magnetization of the second ferromagnetic layer 25 is fixed in the direction y of the applied magnetic field by exchange coupling between the second ferromagnetic layer 25 and the antiferromagnetic layer 26.

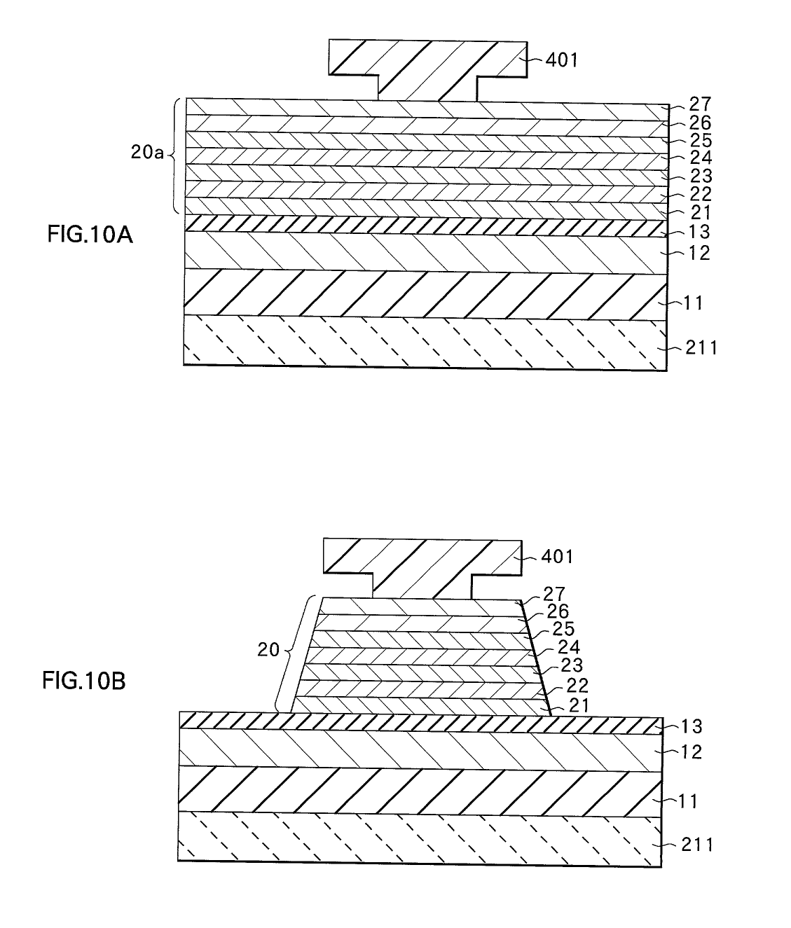

After that, as shown in FIG. 10A, for example, a photoresist film 401 is selectively formed on the protective layer 27 in a region in which the stack 20 is to be formed. Preferably, the photoresist film 401 is T-shaped in cross section by, for example, forming a trench in the interface between the photoresist film 401 and the protective layer 27 so as to facilitate lift-off procedures to be described later.

After forming the photoresist film 401, as shown in FIG. 10B, the protective layer 27, the antiferromagnetic layer 26, the second ferromagnetic layer 25, the nonmagnetic layer 24, the cobalt-containing ferromagnetic layer 23, the nickel-containing ferromagnetic layer 22 and the underlayer 21 are etched in sequence and selectively removed by means of, for example, ion milling using the photoresist film 401 as a mask. Thus, the layers 21 to 27 are formed, and consequently the stack 20 is formed.

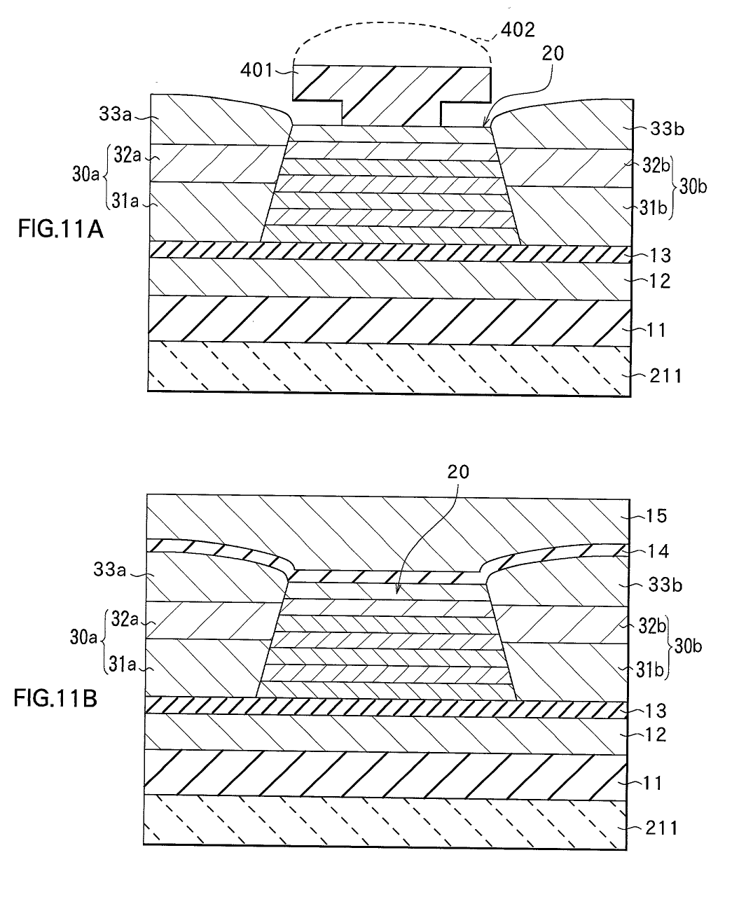

After forming the stack 20, as shown in FIG. 11A, the magnetic domain controlling ferromagnetic films 31a and 31b and the magnetic domain controlling antiferromagnetic films 32a and 32b are formed in sequence on both sides of the stack 20 by sputtering, for example. To form the magnetic domain controlling antiferromagnetic films 32a and 32b by the non-heat-treatment type antiferromagnetic material, the magnetic domain controlling antiferromagnetic films 32a and 32b are formed with the magnetic field applied in the x-direction (see FIG. 7), for example. Thus, the orientations of the magnetizations of the magnetic domain controlling ferromagnetic films 31a and 31b are fixed in the direction x of the applied magnetic field by exchange coupling between the magnetic domain controlling ferromagnetic films 31a and 31b and the magnetic domain controlling antiferromagnetic films 32a and 32b.

After forming the magnetic domain control films 30a and 30b, as shown in FIG. 11A, the lead layers 33a and 33b are formed on the magnetic domain controlling antiferromagnetic films 32a and 32b, respectively, by sputtering, for example. After that, the photoresist film 401 and a deposit 402 stacked thereon (the materials of the magnetic domain controlling ferromagnetic film, the magnetic domain controlling antiferromagnetic film and the lead layer) are removed by lift-off procedures, for example.

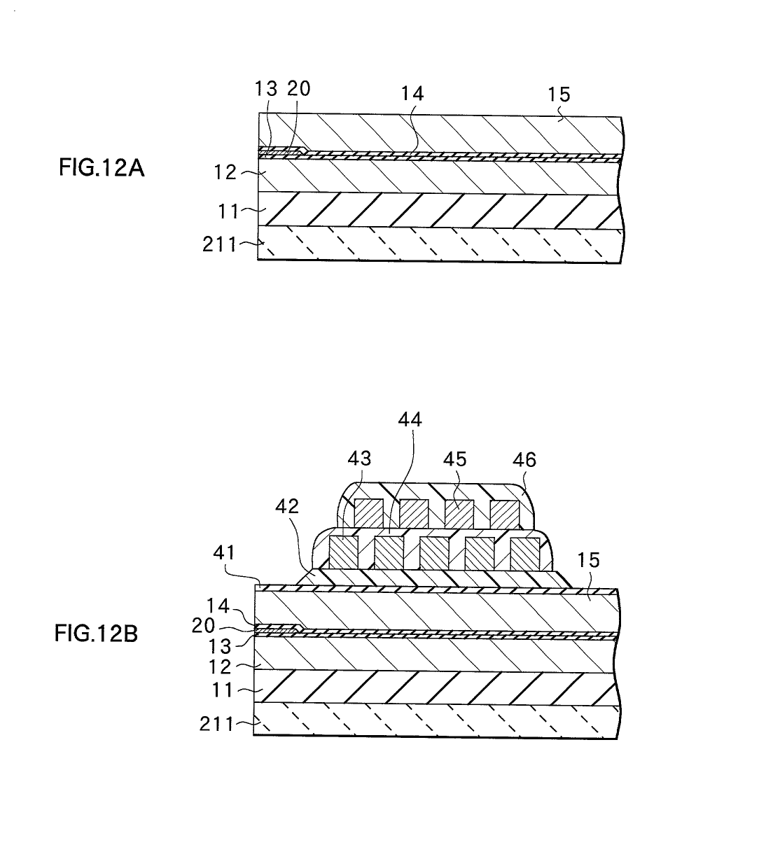

After lift-off procedures, as shown in FIGS. 11B and 12A, the top shield gap layer 14 is formed by, for example, sputtering using the material mentioned in the description of the structure so as to coat the bottom shield gap layer 13 and the stack 20. Thus, the stack 20 is sandwiched in between the bottom shield gap layer 13 and the top shield gap layer 14. After that, the top shield layer 15 is formed on the top shield gap layer 14 by, for example, sputtering using the material mentioned in the description of the structure.

After forming the top shield layer 15, as shown in FIG. 12B, the write gap layer 41 and the photoresist layer 42 are formed in sequence on the top shield layer 15 by, for example, sputtering using the materials mentioned in the description of the structure. The thin film coils 43 are formed on the photoresist layer 42. The photoresist layer 44 is formed into a predetermined pattern so as to coat the thin film coils 43. After forming the photoresist layer 44, the thin film coils 45 are formed on the photoresist layer 44. The photoresist layer 46 is formed into a predetermined pattern so as to coat the thin film coils 45. The thin film coils 43, the photoresist layer 44, the thin film coils 45 and the photoresist layer 46 are formed by use of the materials mentioned in the description of the structure.

After forming the photoresist layer 46, as shown in FIG. 13A, for example, the write gap layer 41 is partly etched at the position corresponding to the center of the thin film coils 43 and 45, whereby the opening 41a for forming a magnetic path is formed. After that, for example, the top pole 47 is formed on the write gap layer 41, the opening 41a and the photoresist layers 42, 44 and 46 by use of the material mentioned in the description of the structure. After forming the top pole 47, for example, the write gap layer 41 and the top shield layer 15 are selectively etched by ion milling using the top pole 47 as a mask. After that, as shown in FIG. 13B, the overcoat layer 48 is formed on the top pole 47 by use of the material mentioned in the description of the structure.

After forming the overcoat layer 48, a process of antiferromagnetizing for fixing the orientations of the magnetic fields of the layer 25 and the films 31a and 31b takes place, for example, to form the second ferromagnetic layer 25 of the stack 20 and the magnetic domain controlling ferromagnetic films 31a and 31b by the heat-treatment type antiferromagnetic material. Specifically, when a blocking temperature (a temperature at which exchange coupling can occur on the interface) of the antiferromagnetic layer 26 and the second ferromagnetic layer 25 is higher than the blocking temperature of the magnetic domain controlling antiferromagnetic films 32a and 32b and the magnetic domain controlling ferromagnetic films 31a and 31b, the thin film magnetic head 100 is heated to the blocking temperature of the antiferromagnetic layer 26 and the second ferromagnetic layer 25 with the magnetic field applied in, for example, the y-direction by utilizing a magnetic field generating apparatus or the like. Thus, the orientation of the magnetization of the second ferromagnetic layer 25 is fixed in the direction y of the applied magnetic field. Subsequently, the thin film magnetic head 100 is cooled to the blocking temperature of the magnetic domain controlling antiferromagnetic films 32a and 32b and the magnetic domain controlling ferromagnetic films 31a and 31b, whereby the magnetic field is applied in the x-direction, for example. Thus, the orientations of the magnetizations of the magnetic domain controlling ferromagnetic films 31a and 31b are fixed in the direction x of the applied magnetic field.

When the blocking temperature of the antiferromagnetic layer 26 and the second ferromagnetic layer 25 is lower than the blocking temperature of the magnetic domain controlling antiferromagnetic films 32a and 32b and the magnetic domain controlling ferromagnetic films 31a and 31b, the process is the reverse of the above procedure. Two heat treatments are not required to form the antiferromagnetic layer 26 or the magnetic domain controlling antiferromagnetic films 32a and 32b by the non-heat-treatment type antiferromagnetic material. In the embodiment, heat treatment for antiferromagnetizing takes place after forming the overcoat layer 48. After forming the second ferromagnetic layer 25 and the antiferromagnetic layer 26, heat treatment may, however, take place before forming the overcoat layer 48. After forming the magnetic domain control films 30a and 30b, heat treatment may take place before forming the overcoat layer 48.

Finally, the air bearing surface is formed by, for example, machining the slider. As a result, the thin film magnetic head 100 shown in FIGS. 3 to 5 is completed.

<Effects of Embodiment>

According to the embodiment, the cobalt-containing ferromagnetic layer 23 has a thickness more than 1 nm. Thus, the amount of resistance change and the rate of resistance change can be improved when the thickness of the nickel-containing ferromagnetic layer 22 is 1 nm or less. Therefore, output can be increased and thus high recording density is achieved.

More particularly, the thickness of the nickel-containing ferromagnetic layer 22 is from 0.2 nm to 0.8 nm inclusive and the thickness of the cobalt-containing ferromagnetic layer 23 is 3.0 nm or less, whereby a larger amount of resistance change and a higher rate of resistance change can be obtained.

Moreover, the nickel-containing ferromagnetic layer 22 contains not only Ni and Fe but also at least one element in a group consisting of Ta, Cr, Nb and Rh, whereby a saturation magnetic flux density decreases and therefore sensitivity improves.

Moreover, the nickel-containing ferromagnetic layer 22 contains, for example, Ni and Fe and the weight ratio of Ni to Fe (Ni/Fe) is from 3.76 to 5.67 inclusive, whereby magnetostriction of the nickel-containing ferromagnetic layer 22 can be easily controlled.

[Modification]

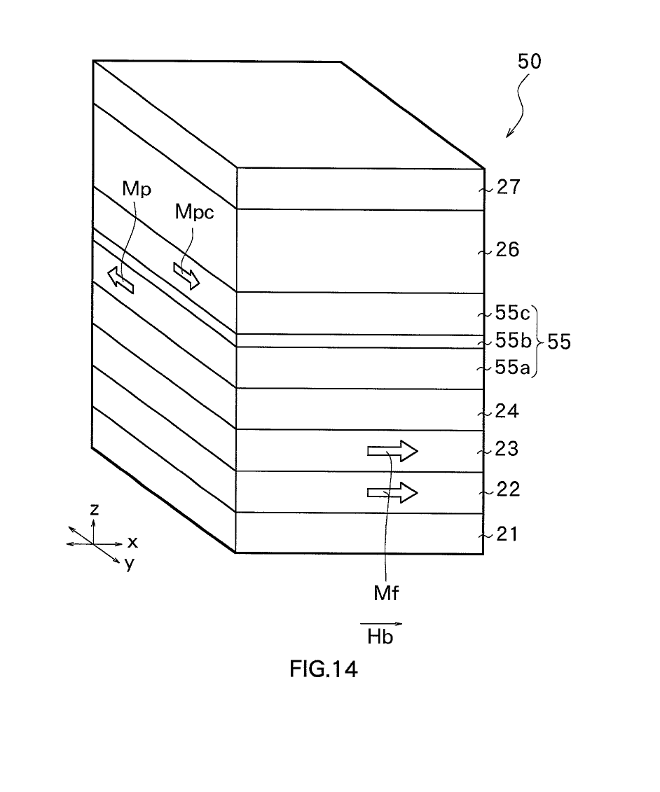

Next, a modification of the embodiment will be described. FIG. 14 shows the structure of a stack 50 according to the modification of the embodiment. The modification has the same structure as the above-described embodiment has, except for the structure of a second ferromagnetic layer 55. Accordingly, the same structural components are indicated by the same reference numerals and symbols, and the detailed description thereof is omitted.

The second ferromagnetic layer 55 has a stacked structure comprising an inside layer 55a, a coupling layer 55b and an outside layer 55c, which are stacked in this order on the nonmagnetic layer 24. The inside layer 55a and the outside layer 55c are made of a magnetic material containing at least Co in a group consisting of Co and Fe, similarly to the above-mentioned second ferromagnetic layer 25. The total thickness of the inside layer 55a and the outside layer 55c is 3 nm to 4.5 nm, for example.

For example, the coupling layer 55b is 0.2 nm to 1.2 nm in thickness and is made of at least one element in a group consisting of Ru, Rh, Re (rhenium), Cr and Zr (zirconium). The coupling layer 55b is a layer for inducing antiferromagnetic exchange coupling between the inside layer 55a and the outside layer 55c and thereby making the magnetization Mp of the inside layer parallel to and opposite to magnetization Mpc of the outside layer. In other words, the second ferromagnetic layer 55 is configured so as to enable the coexistence of the two opposite magnetizations Mp and Mpc. The above-mentioned structure of the second ferromagnetic layer 55 is sometimes called a synthetic pin structure. In the modification, the two opposite magnetizations refer to that an angle between the two magnetizations is 180 degrees plus or minus 20 degrees.

In the modification, the second ferromagnetic layer 55 is configured so as to permit the coexistence of the two opposite magnetizations Mp and Mpc. Thus, it is possible to reduce an influence of the magnetic field generated by the second ferromagnetic layer 55 upon the first ferromagnetic layer (the nickel-containing ferromagnetic layer 22 and the cobalt-containing ferromagnetic layer 23). Therefore, the modification can reduce an influence of any unnecessary magnetic field other than the signal magnetic field upon the first ferromagnetic layer, in addition to the effects of the first embodiment. Accordingly, an effect of improving symmetry of output is achieved.

### EXAMPLES

Specific examples of the invention will be described in detail.

### Examples 1 to 5

The stacks 20 shown in FIG. 7 were prepared as an example 1 and were of fourteen types varying in the thickness of the nickel-containing ferromagnetic layer 22. First, the underlayer 21 of 5 nm thick was formed of Ta by sputtering on each insulating substrate made of Al₂O₃—TiC on which an Al₂O₃ film was formed. The nickel-containing ferromagnetic layer 22 was formed of NiFe on each underlayer 21, and the weight ratio of Ni to Fe was 4.56. After that, the thicknesses of the nickel-containing ferromagnetic layers 22 were varied by every 0.1 nm within a range of from 0.1 nm to 1.0 nm.

Then, the cobalt-containing ferromagnetic layer 23 of 1.3 nm thick was formed of CoFe by sputtering on each nickel-containing ferromagnetic layer 22, and the weight ratio of Co to Fe was 9.0, for example. Subsequently, the nonmagnetic layer 24 of 2.5 nm thick was formed of Cu by sputtering on each cobalt-containing ferromagnetic layer 23. The second ferromagnetic layer 25 of 3 nm thick was formed of CoFe on each nonmagnetic layer 24. The antiferromagnetic layer 26 of 30 nm thick was formed of PtMn on each second ferromagnetic layer 25. The protective layer 27 of 5 nm thick was formed of Ta on each antiferromagnetic layer 26. After forming the layers, heat treatment took place to antiferromagnetize each antiferromagnetic layer 26. Furthermore, each stack 20 was kept at 260° C. for 5 hours under a magnetic field of 636 kA/m, whereby the magnetization thereof was stabilized. After that, the temperature of each stack 20 was decreased to 80° C. at a temperature decreasing speed of 22° C. per hour. In the example 1, an area of each stack 20 was about 3800 mm². The structure of each stack 20 is shown in Table 1.

TABLE 1

| | Nickel-containing | | Cobalt-containing | | | | | | |
|---|---|---|---|---|---|---|---|---|---|
| | ferromagnetic layer | | ferromagnetic | Nonmagnetic layer | | Second ferromagnetic layer | | Antiferromagnetic layer | |
| | | Composition | layer | | Thickness | | Thickness | | Thickness |
| | Material | ratio Ni/Fe | Material | Material | (nm) | Material | (nm) | Material | (nm) |
| Examples | NiFe | 4.56 | CoFe | Cu | 2.5 | CoFe | 3 | PtMn | 30 |
| 1-5 | | | | | | | | | |

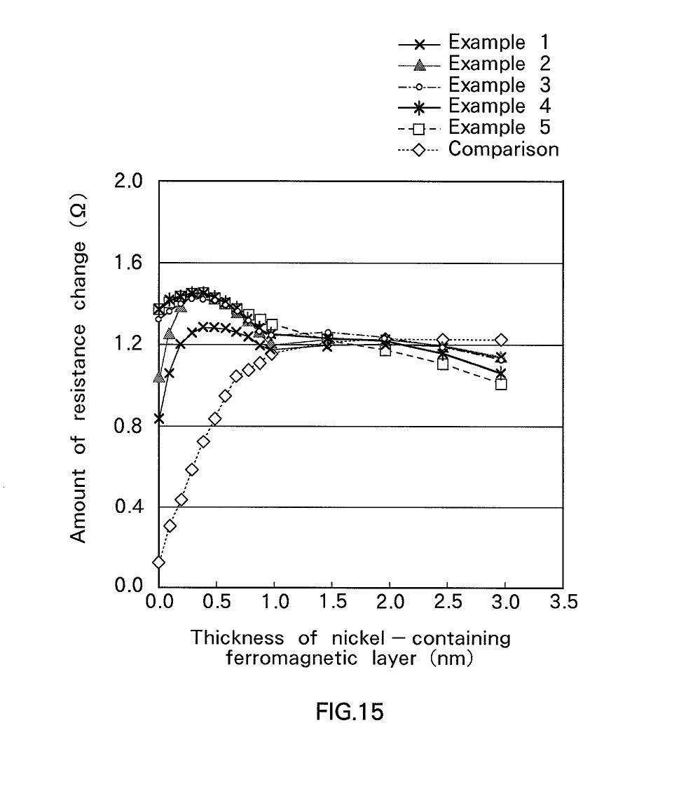

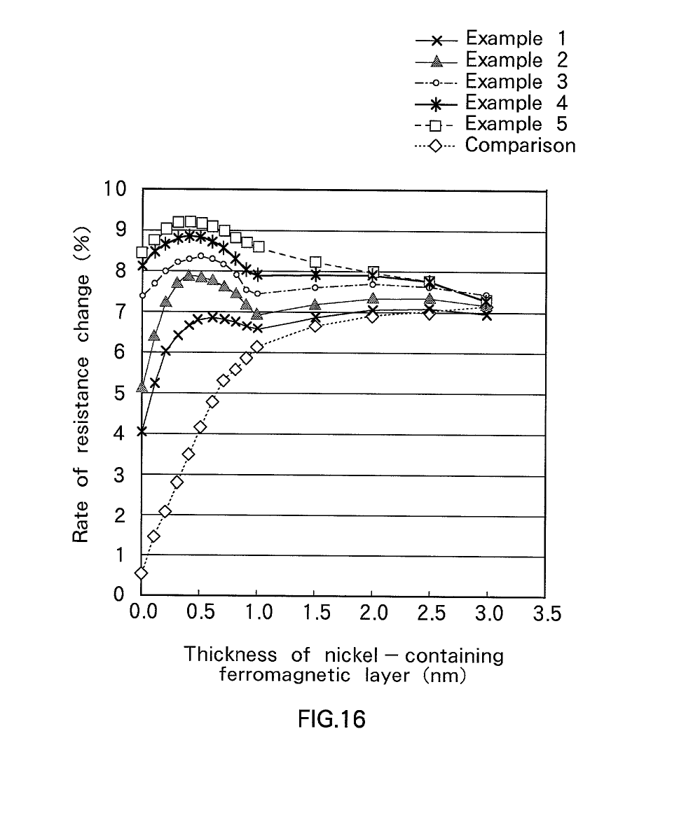

A magnetic field was applied to fourteen types of stacks 20 prepared as described above, concurrently with the passage of a current through the stacks 20. At this time, the amount of resistance change and the rate of resistance change of each stack 20 were examined. The results of examination are shown in FIGS. 15 and 16. For reference purposes, FIGS. 15 and 16 also show the amount of resistance change and the rate of resistance change of stacks prepared under the same condition as the condition for the example 1 except that the nickel-containing ferromagnetic layers 22 had varying thicknesses of 0 nm, 1.5 nm, 2.0 nm, 2.5 nm and 3.0 nm.

As examples 2 to 5, ten types of stacks 20 were prepared for each of the examples 2 to 5 under the same condition as the condition for the example 1 except that the cobalt-containing ferromagnetic layers 23 had varying thicknesses of 1.5 nm, 2.0 nm, 2.5 nm and 3.0 nm as shown in Table 2. The amount of resistance change and the rate of resistance change of each stack 20 were examined in the same manner as the example 1. The results of examination are also shown in FIGS. 15 and 16. FIGS. 15 and 16 also show, as reference values, the amount of resistance change and the rate of resistance change of stacks prepared under the same condition as the condition for the examples 2 to 5 except that the nickel-containing ferromagnetic layers 22 had varying thicknesses of 0 nm, 1.5 nm, 2.0 nm, 2.5 nm and 3.0 nm, similarly to the example 1.

TABLE 2

| | Thickness of |
|---|---|
| | cobalt-containing |
| | ferromagnetic layer |
| | (nm) |
| Examples | |
| 1 | 1.3 |
| 2 | 1.5 |
| 3 | 2.0 |
| 4 | 2.5 |
| 5 | 3.0 |
| Comparison | 1.0 |

Fourteen types of stacks were prepared as a comparison to the examples under the same condition as the condition for the example 1 except that the cobalt-containing ferromagnetic layer had a thickness of 1 nm as shown in Table 2. Properties of the comparison were examined in the same manner as the examples. The results of examination are also shown in FIGS. 15 and 16. FIGS. 15 and 16 also show, as reference values, the amount of resistance change and the rate of resistance change of stacks prepared under the same condition as the condition for the comparison except that the nickel-containing ferromagnetic layers had varying thicknesses of 0 nm, 1.5 nm, 2.0 nm, 2.5 nm and 3.0 nm.

As can be seen from FIGS. 15 and 16, the examples in which the cobalt-containing ferromagnetic layers 23 had thicknesses varying from 1.3 nm to 3 nm could improve the amount of resistance change and the rate of resistance change when the thickness of the nickel-containing ferromagnetic layer 22 was within a range of 1 nm or less, as compared to the comparison in which the cobalt-containing ferromagnetic layer 23 had a thickness of 1 nm. The examples exhibited the respective peaks of the amount of resistance change and the rate of resistance change, when the thickness of the nickel-containing ferromagnetic layer 22 was within a range of from 0.2 nm to 0.8 nm.

In other words, it turns out that the thickness of the cobalt-containing ferromagnetic layer 23 is more than 1 nm, whereby, when the thickness of the nickel-containing ferromagnetic layer 22 is within a range of 1 nm or less, both the amount of resistance change and the rate of resistance change can be improved and therefore high output can be obtained. More particularly, it turns out that the thickness of the nickel-containing ferromagnetic layer 22 is within a range of from 0.2 nm to 0.8 nm inclusive, whereby a larger amount of resistance change and a higher rate of resistance change can be obtained.

### Examples 6 to 11

As examples 6 to 11, ten types of stacks 20 or 50 shown in FIG. 7 or 14 were prepared for each of the examples 6 to 11 in the same manner as the example 1. It should be noted that the structures of the nickel-containing ferromagnetic layer 22, the cobalt-containing ferromagnetic layer 23, the nonmagnetic layer 24, the second ferromagnetic layer 25 and the antiferromagnetic layer 26 were changed as shown in Table 3 according to the examples 6 to 11.

TABLE 3

| | Nickel-containing | | | | | |
|---|---|---|---|---|---|---|
| | ferromagnetic layer | | Cobalt-containing | | | |
| | | Composi- | ferromagnetic layer | | Nonmagnetic layer | |
| | | tion | | Thickness | | Thickness |
| | Material | ratio Ni/Fe | Material | (nm) | Material | (nm) |
| Exam- | | | | | | |
| ples | | | | | | |
| 6 | NiFe | 5.67 | Co | 1.5 | Cu | 2.3 |
| 7 | NiFe | 3.76 | CoFe | 2.0 | Cu | 2.4 |
| 8 | NiFeCr | 4.00 | Co | 2.0 | Cu | 2.7 |
| 9 | NiFeRh | 4.00 | Co | 2.0 | Cu | 2.6 |
| 10 | NiFeNb | 4.00 | Co | 2.0 | Cu | 2.4 |
| 11 | NiFeTa | 4.00 | Co | 2.0 | Cu | 3.0 |

| | |
|---|---|
| Second ferromagnetic layer | Antiferromagnetic layer |

| | | Thickness | | Thickness |
|---|---|---|---|---|
| | Material | (nm) | Material | (nm) |
| Examples | | | | |
| 6 | Co | 2.5 | IrMn | 7 |
| 7 | CoFe | 4.3 | PtMn | 30 |
| 8 | CoFe/Co | 4.3 | PtMn | 30 |
| 9 | Co | 2.5 | PtMn | 30 |
| 10 | Co | 2.2 | RuRhMn | 80 |
| 11 | Co | 2.0 | RuMn | 80 |

Notes: The second ferromagnetic layer of the example 7 had a stacked structure comprising CoFe (2.5 nm), Ru (0.8 nm) and CoFe (1.8 nm), which were stacked in this order on the nonmagnetic layer. The second ferromagnetic layer of the example 8 had a stacked structure comprising Co (2.5 nm), Ru (0.8 nm) and CoFe (1.8 nm), which were stacked in this order on the nonmagnetic layer.

In the example 6, the nickel-containing ferromagnetic layer 22 was formed of NiFe, and the weight ratio of Ni to Fe was 5.67. The cobalt-containing ferromagnetic layer 23 was formed of Co of 1.5 nm thick. The nonmagnetic layer 24 was formed of Cu of 2.3 nm thick. The second ferromagnetic layer 25 was formed of Co of 2.5 nm thick. The antiferromagnetic layer 26 was formed of IrMn of 7 nm thick. In the example 7, the nickel-containing ferromagnetic layer 22 was formed of NiFe, and the weight ratio of Ni to Fe was 3.76. The cobalt-containing ferromagnetic layer 23 was formed of CoFe of 2.0 nm thick. The nonmagnetic layer 24 was formed of Cu of 2.4 nm thick. The second ferromagnetic layer 25 was formed of CoFe of 2.5 nm thick, Ru of 0.8 nm thick and CoFe of 1.8 nm thick (which were stacked in this order on the nonmagnetic layer 24). The antiferromagnetic layer 26 was formed of PtMn of 30 nm thick. That is, the stack of the example 7 had the synthetic pin structure shown in FIG. 14.

In the example 8, the nickel-containing ferromagnetic layer 22 was formed of NiFeCr, and the weight ratio of Ni to Fe was 4.00. The cobalt-containing ferromagnetic layer 23 was formed of Co of 2.0 nm thick. The nonmagnetic layer 24 was formed of Cu of 2.7 nm thick. The second ferromagnetic layer 25 was formed of Co of 2.5 nm thick, Ru of 0.8 nm thick and CoFe of 1.8 nm thick (which were stacked in this order on the nonmagnetic layer 24). The antiferromagnetic layer 26 was formed of PtMn of 30 nm thick. That is, the stack of the example 8 had the synthetic pin structure shown in FIG. 14. In the example 9, the nickel-containing ferromagnetic layer 22 was formed of NiFeRh, and the weight ratio of Ni to Fe was 4.00. The cobalt-containing ferromagnetic layer 23 was formed of Co of 2.0 nm thick. The nonmagnetic layer 24 was formed of Cu of 2.6 nm thick. The second ferromagnetic layer 25 was formed of Co of 2.5 nm thick. The antiferromagnetic layer 26 was formed of PtMn of 30 nm thick.

In the example 10, the nickel-containing ferromagnetic layer 22 was formed of NiFeNb, and the weight ratio of Ni to Fe was 4.00. The cobalt-containing ferromagnetic layer 23 was formed of Co of 2.0 nm thick. The nonmagnetic layer 24 was formed of Cu of 2.4 nm thick. The second ferromagnetic layer 25 was formed of Co of 2.2 nm thick. The antiferromagnetic layer 26 was formed of RuRhMn of 8 nm thick. In the example 11, the nickel-containing ferromagnetic layer 22 was formed of NiFeTa, and the weight ratio of Ni to Fe was 4.00. The cobalt-containing ferromagnetic layer 23 was formed of Co of 2.0 nm thick. The nonmagnetic layer 24 was formed of Cu of 3.0 nm thick. The second ferromagnetic layer 25 was formed of Co of 2.0 nm thick. The antiferromagnetic layer 26 was formed of RuMn of 8 nm thick.

In the examples 6, 10 and 11, the antiferromagnetic layer 26 was formed of the non-heat-treatment type antiferromagnetic material. Thus, the antiferromagnetic layer 26 was formed while being subjected to an applied magnetic field, and the antiferromagnetic layer 26 was not antiferromagnetized after being formed.

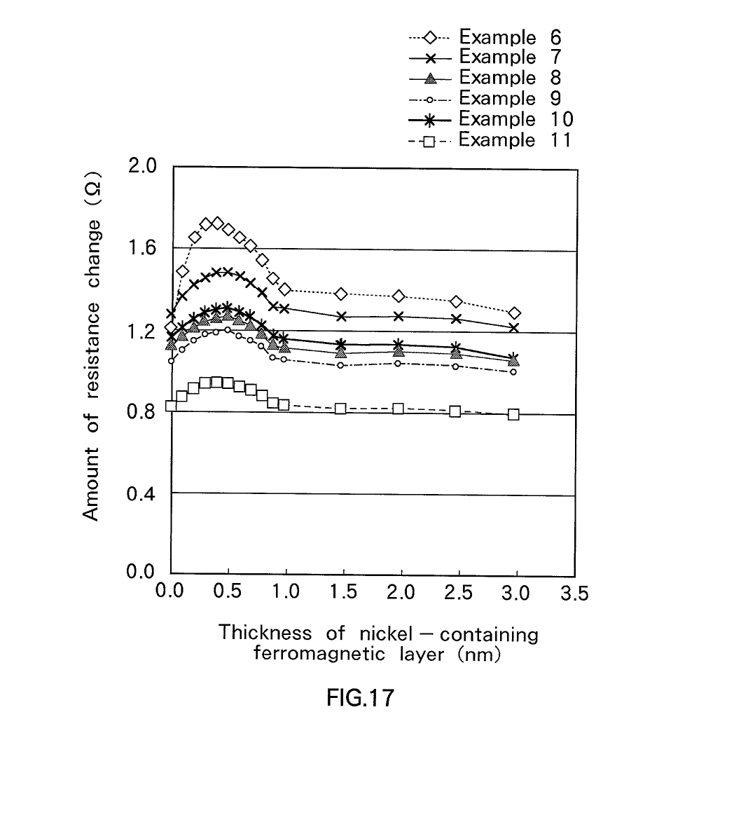

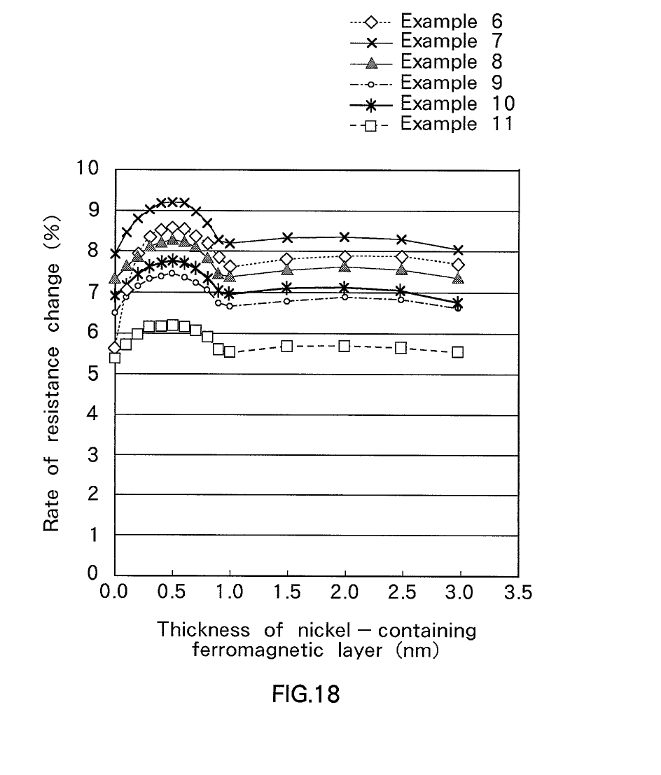

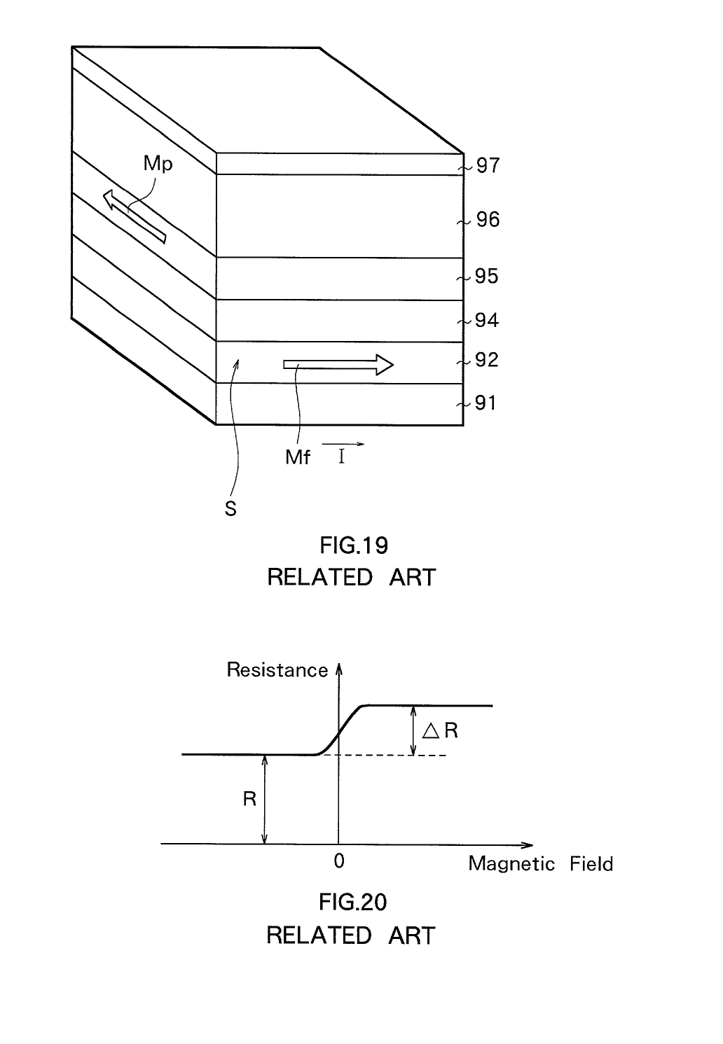

The amount of resistance change and the rate of resistance change of the examples 6 to 11 were examined in the same manner as the example 1. The results of examination are shown in FIGS. 17 and 18. FIGS. 17 and 18 also show, as reference values, the amount of resistance change and the rate of resistance change of stacks prepared under the same condition as the condition for the examples 6 to 11 except that the nickel-containing ferromagnetic layers 22 had varying thicknesses of 1.5 nm, 2.0 nm, 2.5 nm and 3.0 nm, similarly to the example 1. As can be seen from FIGS. 17 and 18, the examples 6 to 11 did not exhibit a unidirectional reduction in the amount of resistance change and the rate of resistance change when the thickness of the nickel-containing ferromagnetic layer 22 was within a range of 1 nm or less, and the examples 6 to 11 exhibited the respective peaks of the amount of resistance change and the rate of resistance change when the thickness of the nickel-containing ferromagnetic layer 22 was within a range of from 0.2 nm to 0.8 nm. In other words, it has been shown that, even if the structure of the stack 20 or 50 is changed, the cobalt-containing ferromagnetic layer 23 having a thickness of more than 1 nm can improve both the amount of resistance change and the rate of resistance change even when the thickness of the nickel-containing ferromagnetic layer 22 is within a range of 1 nm or less.

Although the stacks of the above-mentioned examples have been specifically described by referring to some examples, stacks having other structures can achieve the same effects.

Although the invention has been described above by referring to the embodiment and the examples, the invention is not limited to these embodiment and examples and various modifications of the invention are possible. For example, in the above-mentioned embodiment and examples, the description has been given with regard to the case in which the nickel-containing ferromagnetic layer 22, the cobalt-containing ferromagnetic layer 23, the nonmagnetic layer 24, the second ferromagnetic layer 25 and the antiferromagnetic layer 26 are stacked in order in such a manner that the nickel-containing ferromagnetic layer 22 is the undermost layer. However, the layers 22, 23, 24, 25 and 26 may be stacked in reverse order, i.e., in such a manner that the antiferromagnetic layer is the undermost layer. In other words, the invention can be widely applied to a magnetic transducer having a nonmagnetic layer having a pair of facing surfaces, a first ferromagnetic layer formed on one surface of the nonmagnetic layer, a second ferromagnetic layer formed on the other surface of the nonmagnetic layer, and an antiferromagnetic layer formed on the second ferromagnetic layer on the side opposite to the nonmagnetic layer.

As the magnetic domain control films 30a and 30b shown in FIG. 6, the magnetic domain controlling ferromagnetic films 31a and 31b and the magnetic domain controlling antiferromagnetic films 32a and 32b may be replaced with a hard magnetic material (a hard magnet). In this case, a stacked film of a TiW layer and a CoPt (cobalt-platinum alloy) layer or a stacked film of a TiW layer and a CoCrPt (cobalt-chromium-platinum alloy) layer may be formed by sputtering, for example.

In the above-mentioned embodiment, both the antiferromagnetic layer 26 and the magnetic domain controlling antiferromagnetic films 32a and 32b are made of the heat-treatment type antiferromagnetic material. However, the antiferromagnetic layer 26 and the magnetic domain controlling antiferromagnetic films 32a and 32b may be made of the heat-treatment type antiferromagnetic material and the non-heat-treatment type antiferromagnetic material, respectively. Alternatively, the antiferromagnetic layer 26 and the magnetic domain controlling antiferromagnetic films 32a and 32b may be made of the non-heat-treatment type antiferromagnetic material and the heat-treatment type antiferromagnetic material, respectively. Alternatively, both the antiferromagnetic layer 26 and the magnetic domain controlling antiferromagnetic films 32a and 32b may be made of the non-heat-treatment type antiferromagnetic material.

In the above-mentioned embodiment, the description has been given with regard to the case in which the magnetic transducer of the invention is used in a composite thin film magnetic head. However, the magnetic transducer of the invention can be also used in a thin film magnetic head for reproducing only. Moreover, the recording head and the reproducing head may be stacked in reverse order. Additionally, the configuration of the magnetic transducer of the invention may be applied to a tunnel junction type magnetoresistive film (a TMR film). Furthermore, the magnetic transducer of the invention is applicable to, for example, a sensor (an accelerometer or the like) for detecting a magnetic signal, a memory for storing a magnetic signal, or the like, as well as the thin film magnetic head described by referring to the above-mentioned embodiment.

As described above, according to the magnetic transducer or the thin film magnetic head of the invention, the thickness of the cobalt-containing ferromagnetic layer is more than 1 nm. Thus, the amount of resistance change and the rate of resistance change can be improved when the thickness of the nickel-containing ferromagnetic layer is 1 nm or less. Therefore, output can be increased and thus adaptation can be made to high recording density.

More particularly, when the thickness of the nickel-containing ferromagnetic layer is from 0.2 nm to 0.8 nm inclusive or the thickness of the cobalt-containing ferromagnetic layer is 3.0 nm or less, a larger amount of resistance change and a higher rate of resistance change can be obtained.

When the nickel-containing ferromagnetic layer is made of not only Ni and Fe but also at least one element in a group consisting of Ta, Cr, Nb and Rh, the saturation magnetic flux density decreases and therefore the sensitivity improves.

Obviously many modifications and variations of the present invention are possible in the light of the above teachings. It is therefore to be understood that within the scope of the appended claims the invention may be practiced otherwise than as specifically described.

What is claimed is:

1. A magnetic transducer comprising:
a nonmagnetic layer having a pair of surfaces facing each other;
a first ferromagnetic layer formed on one surface of the nonmagnetic layer;
a second ferromagnetic layer formed on the other surface of the nonmagnetic layer; and
an antiferromagnetic layer formed on the second ferromagnetic layer on the side opposite to the nonmagnetic layer, wherein the first ferromagnetic layer includes a nickel-containing ferromagnetic layer containing at least nickel in a group consisting of nickel (Ni), cobalt (Co) and iron (Fe), and a cobalt-containing ferromagnetic layer formed on the nickel-containing ferromagnetic layer on the side close to the nonmagnetic layer and containing at least cobalt in a group consisting of nickel, cobalt and iron,
a thickness of the nickel-containing ferromagnetic layer is 1 nm or less, and
a thickness of the cobalt-containing ferromagnetic layer is more than 1 nm.

2. A magnetic transducer according to claim 1, wherein the thickness of the nickel-containing ferromagnetic layer is from 0.2 nm to 0.8 nm inclusive.

3. A magnetic transducer according to claim 1, wherein the thickness of the cobalt-containing ferromagnetic layer is 3 nm or less.

4. A magnetic transducer according to claim 1, wherein the nickel-containing ferromagnetic layer further contains at least one element in a group consisting of tantalum (Ta), chromium (Cr), niobium (Nb) and rhodium (Rh).

5. A magnetic transducer according to claim 1, wherein the second ferromagnetic layer contains at least cobalt in a group consisting of cobalt and iron.

6. A magnetic transducer according to claim 1, wherein the antiferromagnetic layer contains manganese (Mn) and at least one element in a group consisting of platinum (Pt), ruthenium (Ru), rhodium (Rh) and iridium (Ir).

7. A magnetic transducer according to claim 1, wherein the non magnetic layer contains at least one element in a group consisting of copper (Cu), gold (Au) and silver (Ag).

8. A thin film magnetic head having a magnetic transducer,
the magnetic transducer comprising:
a nonmagnetic layer having a pair of surfaces facing each other;
a first ferromagnetic layer formed on one surface of the nonmagnetic layer;
a second ferromagnetic layer formed on the other surface of the nonmagnetic layer; and
an antiferromagnetic layer formed on the second ferromagnetic layer on the side opposite to the nonmagnetic layer,
wherein the first ferromagnetic layer includes a nickel-containing ferromagnetic layer containing at least nickel in a group consisting of nickel, cobalt and iron, and a cobalt-containing ferromagnetic layer formed on the nickel-containing ferromagnetic layer on the side close to the nonmagnetic layer and containing at least cobalt in a group consisting of nickel, cobalt and iron,
a thickness of the nickel-containing ferromagnetic layer is 1 nm or less, and
a thickness of the cobalt-containing ferromagnetic layer is more than 1 nm.
